(19) United States
(12) Patent Application Publication
(10) Pub. No.: US 2007/0099606 A1
(43) Pub. Date: May 3, 2007

(54) Emulating device

(76) Inventors: Timo Strohlein, Herne (DE); Mikko Suni, Espoo (FI); Ulrich Muller, Herne (DE); Volker Deichmann, Wuppertal (DE); Paul James, Bochum (DE); Jan Frey, Bochum (DE)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 11/316,972

(22) Filed: Dec. 27, 2005

(30) Foreign Application Priority Data
Nov. 2, 2005 (FI) 20055589

(51) Int. Cl. H04Q 7/20

(52) U.S. Cl. 455/423

(57) ABSTRACT

A method and a corresponding device for optimising a cellular telecommunication network are provided. According to the provided method, an emulating device is connected to the cellular telecommunication network, thus creating a signalling link between the emulating device and the cellular telecommunication network. With the emulating device, functionalities of elements of the cellular telecommunication network are emulated and data traffic is created to an air interface of the cellular telecommunication network. The effects of created data traffic on the cellular telecommunication network are then measured and the cellular telecommunication network is adjusted on the basis of the measurements.

### FIELD

The invention relates to analysis and optimisation of a cellular telecommunication network.

### BACKGROUND

When designing a cellular telecommunication network, issues such as good quality of service (QoS), coverage, capacity, etc. are taken into account. Even though the design phase has been carried out with all due care, there arises a need for optimisation during the deployment and operational phases of the cellular telecommunication network.

In addition to field-testing by carrying out measurements of signal and radio link qualities, data traffic between user terminals and the cellular telecommunication network may be monitored during the operational stage of the cellular telecommunication system. A network operator may monitor and analyse the data exchanged between the subscriber units and the network in order to detect deficiencies in, for example, coverage, capacity, and/or throughput of the telecommunication network. The network operator may then optimise the telecommunication network on the basis of the analysis in order to provide a better QoS. The optimisation may comprise optimisation of radio resource management, neighbour list, antenna direction, and/or pilot power, for example.

A problem in optimising the cellular telecommunication network according to the procedure described above is that the traffic between the subscriber units and the network is random and cannot be affected in any way. Therefore, in order to detect deficiencies in the telecommunication network under a high load it has to be waited until the network is loaded with a sufficient number of radio connections of real subscribers. This behaviour is unpredictable and it may take a long time until suitable conditions are available.

A prior art solution for detecting deficiencies in a telecommunication network (particularly UMTS radio access network) is to artificially increase downlink interference by increasing the transmission power of common channels. Then, effects of increased interference may be measured or detected and the telecommunication network may be adjusted in order to provide a better QoS. This solution, however, creates an unrealistic environment, since the load on the network is not created by real subscribers and real traffic. Therefore, the effects of this solution are limited.

### BRIEF DESCRIPTION OF THE INVENTION

An object of the invention is to provide an improved cellular telecommunication network optimisation method, an improved analysis device, an improved arrangement, an improved computer program product, and an improved computer program distribution medium.

According to an aspect of the invention, there is provided a cellular telecommunication network optimisation method. The method comprises connecting an emulating device to the cellular telecommunication network, thus creating a signalling link between the emulating device and the cellular telecommunication network. The method further comprises emulating, with the emulating device, functionalities of elements of the cellular telecommunication network, creating, with the emulating device, data traffic to an air interface of the cellular telecommunication network, measuring effects of created data traffic on the cellular telecommunication network; and adjusting the cellular telecommunication network on the basis of the measurements.

According to another aspect of the invention, there is provided an emulating device comprising a communication interface for connecting the emulating device to a network element of a cellular telecommunication network. The emulating device further comprises a processing unit configured to emulate functionalities of elements of the cellular telecommunication network, to create data traffic to be transmitted to an air interface of the cellular telecommunication network, and to control a real base station of the cellular telecommunication network to transmit the created data traffic to the air interface in order to increase load of the cellular telecommunication network.

According to another aspect of the invention, there is provided an arrangement which comprises a cellular telecommunication network comprising one or more base stations and other network elements, an emulating device comprising a communication interface for connecting the emulating device to a network element of a cellular telecommunication network, and measuring instruments capable of measuring properties of the cellular telecommunication network. The emulating device further comprises a processing unit configured to emulate functionalities of elements of the cellular telecommunication network, to create data traffic to be transmitted to an air interface of the cellular telecommunication network, and to control a real base station of the cellular telecommunication network to transmit data traffic to an air interface in order to increase load of the cellular telecommunication network.

According to yet another aspect of the invention, there is provided a computer program product encoding a computer program of instructions for executing a computer process for cellular telecommunication network optimisation. The process comprises emulating functionalities of elements of the cellular telecommunication network, creating data traffic to be transmitted to an air interface of the cellular telecommunication network, and controlling a base station of the cellular telecommunication network to transmit the created data traffic to an air interface in order to increase load of the cellular telecommunication network.

According to still another aspect of the invention, there is provided a computer program distribution medium readable by a computer and encoding a computer program of instructions for executing a computer process for cellular telecommunication network optimisation. The process comprises emulating functionalities of elements of the cellular telecommunication network, creating data traffic to be transmitted to an air interface of the cellular telecommunication network, and controlling a base station of the cellular telecommunication network to transmit the created data traffic to an air interface in order to increase load of the cellular telecommunication network.

The invention provides several advantages. The invention creates real data traffic to the cellular telecommunication network, which models the presence of real users realistically. Therefore, a more reliable analysis on the performance of the cellular telecommunication network may be obtained under increased load. The invention may be used to create deterministic data to the cellular telecommunication network and the amount of data may be controlled in order to obtain a desired load on the cellular telecommunication network. The invention requires no modifications to the existing cellular telecommunication networks which have already been deployed. Additionally, the invention may be implemented with inexpensive hardware components.

### LIST OF DRAWINGS

In the following, the invention will be described in greater detail with reference to the embodiments and the accompanying drawings, in which

FIG. 1 illustrates the structure of an emulating device according to an embodiment of the invention;

FIG. 2A illustrates an arrangement for connecting the emulating device to a cellular telecommunication network according to an embodiment of the invention;

FIG. 2B illustrates another arrangement for connecting the emulating device to a cellular telecommunication network according to an embodiment of the invention;

FIG. 3 illustrates operation of the emulating device together with the cellular telecommunication network according to an embodiment of the invention;

FIG. 4 is a diagram illustrating signalling between elements emulated by the emulating device and elements of the cellular telecommunication network according to an embodiment of the invention;

FIG. 5 illustrates an arrangement for optimising the cellular telecommunication network according to an embodiment of the invention, and

FIG. 6 is a flow diagram illustrating a process for optimising the cellular telecommunication network according to an embodiment of the invention.

### DESCRIPTION OF EMBODIMENTS

Next, embodiments of the invention will be described in conjunction with Universal Mobile Telecommunications System (UMTS) but a skilled person may modify the embodiments in order to implement the invention in other cellular telecommunication networks.

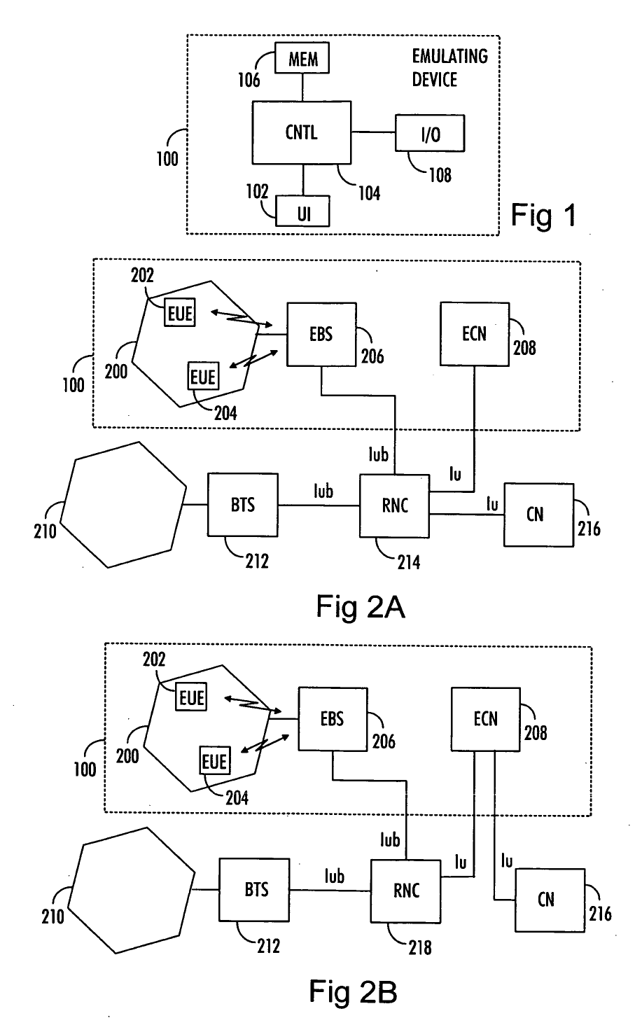

With reference to FIG. 1, examine an example of an emulating device 100 in which embodiments of the invention can be applied.

The emulating device 100 comprises a communication interface 108 for connecting the emulating device 100 to a cellular telecommunication network. The communication interface 108 may comprise connectors for connecting the emulating device 100 to a radio network controller (RNC) of the UMTS and, particularly, to lu and lub interfaces of the RNC. This connection provides signalling links between the emulating device 100 and the cellular telecommunication network. Additionally, the communication interface 108 may comprise other connectors for connecting the emulating device 100 to the other elements of the cellular telecommunication network.

The emulating device 100 further comprises a processing unit 104 configured to control operations of the emulating device 100. The processing unit 104 controls, among others, emulation processes carried out in the emulating device 100 and signalling between the emulating device 100 and the cellular telecommunication network. The processing unit 104 may be implemented by a digital signal processor or by a multi-purpose processor (such as the processor of a PC) with suitable software embedded on a computer readable medium, or by separate logic circuits, for example with ASIC (Application Specific Integrated Circuit).

The emulating device 100 may further comprise a memory unit 106 storing instructions for executing processes in the emulating device 100. The memory unit may be any non-volatile memory unit known in the art.

The emulating device 100 may further comprise a user interface 102 for interaction with a user of the emulating device 100. The user interface may comprise a keyboard or another input unit for inputting information and commands, and a display unit for displaying information.

Consequently, the emulating device 100 requires no expensive hardware components, since it may be implemented with a personal computer and suitable connectors for connecting the emulating device 100 to the cellular telecommunication network.

Next, an arrangement of connecting the emulating device 100 to the cellular telecommunication network is described with reference to FIGS. 2A and 2B which illustrate alternative embodiments of connecting the emulating device 100 to the cellular telecommunication network.

As mentioned above, the cellular telecommunication network in this exemplary embodiment is a UMTS network. The cellular telecommunication network comprises a core network 216, a radio network controller 214, and a base station 212 (or Node B which is the equivalent term in the UMTS specifications provided by 3^{rd} Generation Partnership Project, 3GPP). The core network 216 takes care of switching and routing calls and data connections of user terminals served by the cellular telecommunication network. The core network also performs procedures related to radio resource management. The core network 216 may provide circuit-switched and/or packet-switched data transport services to the user terminals.

A radio network controller (RNC) 214 is the network element which is responsible for the control of radio resources. The RNC 214 serves as a switching and controlling element and typically controls several base stations 212, but it may also control only a single base station 212. The RNC 214 is responsible for controlling load and congestion of traffic channels of its own cells. The RNC 14 also takes care of procedures related to admission control, handovers, and power control. The RNC 214 connects to the core network 216 through an interface which is known as the lu interface.

A base station (BTS) 212 is responsible for providing an air interface radio connection to the user terminals within its coverage area, also known as a cell 210. The BTS 212 also performs physical level signal processing like modulation, channel coding, etc. The BTS 212 may also perform some basic radio resource management operations like operations related to power control. The BTS 212 connects to the RNC through an interface which is known as the lub interface.

One purpose of the emulating device 100 is to create deterministic traffic to an air interface of the cellular telecommunication network in order to increase the load of the network. By measuring effects of the increased load on the network, deficiencies in the network may be identified and the network may be optimised.

The emulating device 100 may emulate functionalities of certain elements of the cellular telecommunication network. The emulating device 100 may comprise entities such as emulated core network 208, emulated base station 206, and one or more emulated user terminals 202, 204. These entities may be computer processes executed in the emulating device 100.

The emulated base station 206 emulates functionalities of a real base station 212 of the cellular telecommunication network. The emulated base station 206 provides communication services for the emulated user terminals 202, 204 within an emulated cell 200. The emulated base station 206 may be connected to the cellular telecommunication system through the communication interface 108, which may provide a connection to the radio network controller 214 through the lub interface. Once the emulating device 100 is connected to the lub interface of the RNC 214 and the RNC detects the presence of a new base station, the RNC may establish a signalling connection with the emulated base station 206 as it would with a real base station 212 of the cellular telecommunication network. Accordingly, the RNC 214 cannot differentiate whether it is communicating with a real base station or an emulated base station.

The emulated core network 208 emulates functionalities of a real core network 216 of the cellular telecommunication network. The emulated core network 208 takes care of switching and routing data traffic to the emulated user terminals 202, 204. The emulated core network 208 may also perform radio resource management and connection management operations related to the emulated user terminals. The emulated core network 208 may be connected to the cellular telecommunication system through the communication interface 108, which may provide a connection to the radio network controller 214 through the lu interface. After connecting the emulated core network 208 to the RNC 214, a signalling connection may be established between them according to standard UMTS signalling. At this stage, it should be noted that the real core network 216 carries out switching and routing of data traffic of real user terminals served by the cellular telecommunication network, while the emulated core network switches and routes the data traffic related to emulated user terminals 202, 204.

FIG. 2A illustrates an arrangement in which the real core network 216 and the emulated core network 208 are connected to different lu interfaces of the radio network controller 214 and the core networks operate in parallel. FIG. 2B illustrates another arrangement comprising a radio network controller 218 which supports only one core network. In this case , the emulated core network 208 may be connected between the radio network controller 218 and the real core network 216. The emulated core network 208 then processes operations related to the emulated user terminals 202, 204 and simply forwards information and instructions between the radio network controller 218 and the real core network 216.

Once the emulated base station 206 and the emulated core network 208 have been connected to the cellular telecommunication network, the one or more emulated user terminals 202, 204 are introduced to the cellular telecommunication network. Signalling connections between the emulated user terminals 202, 204 and the cellular telecommunication network are established according to the specifications of the cellular telecommunication network (UMTS in this example) through the emulated base station 206 which serves the emulated user terminals 202, 204 located within the emulated cell 200. At this stage, only control signalling comprising air interface measurements is transferred between the emulated user terminals 202, 204 and the cellular telecommunication network. Thus, no data traffic is transferred at this stage.

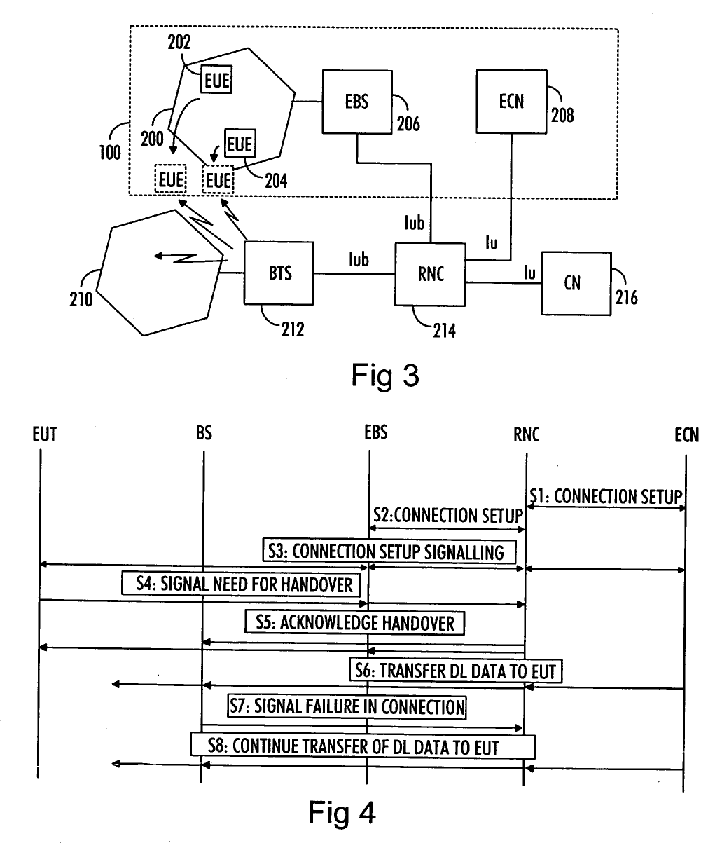

Next, operations performed after the connections between the entities of the emulating device 100 and the cellular telecommunication network have been established will be described with reference to FIG. 3.

After the radio links between the emulated user terminals 202, 204 and the cellular telecommunication network have been established, the emulated user terminals 202, 204 are moved towards a real cell 210 of the cellular telecommunication network, i.e. towards the real base station 212. In practice, the movement of emulated user terminals 202, 204 is carried out by producing emulated air interface measurement results for each emulated user terminal 202, 204 and transmitting these measurement results through the emulated base station 206 to the radio network controller 214. The measurement results may indicate an increasing power level of a pilot signal received from the real base station 212. This operation may be carried out, for example, by generating, in the emulated user terminals 202, 204, the air interface measurement results which indicate that a stronger pilot signal is being received from the real base station 212. These measurement results are then transmitted via the emulated base station 206 to the RNC 214 together with corresponding measurement results related to the emulated base station 206. The RNC 214 then compares the measurement results and determines that the emulated user terminals 202, 204 should be handed over to the real base station 212, because the emulated user terminals 202, 204 receive a stronger pilot signal from the real base station 212. The RNC 214 then transmits the acknowledgment of handover and necessary handover information to the real base station 212, the emulated base station 206, and the emulated user terminals 202, 204 which were handed over to the real base station.

The emulated user terminals 202, 204 are now served by the real base station 212. It should be noted that the handover procedure may be carried out without any communication between the emulated user terminals 202, 204 and the real base station, excluding the reception of the pilot signal from the real base station 212.

When the emulated user terminals 202, 204 have been handed over to the real base station 212, data traffic is created in the emulating device 100 for each emulated user terminal 202, 204. The data traffic may be downlink data traffic which may be generated by using an application called “orthogonal channel noise simulation” which generates a high amount of downlink data into the cellular telecommunication network (particularly UMTS network). The data traffic may also comprise control information necessary for delivering the data traffic to a specific user terminal. This data traffic is then transmitted from the emulating device to the cellular telecommunication network through the emulated core network 208, which switches and routes the created data traffic to each emulated user terminal 202, 204. The emulated core network 208 then transmits the created data traffic with routing information through the lu interface to the RNC 214, which then conveys the data traffic to the real base station 212. The real base station then transmits the data traffic to the air interface of the real cell 210 in order to transmit the data traffic to the emulated user terminals 202, 204. Thus, total amount of data traffic in the real cell 210 is increased, thereby increasing the load of the cell.

Since the emulated user terminals 202, 204 have no real air interface communication connection with the real base station 212, the data traffic transmitted by the real base station 212 is never received and the reception of the data traffic is never acknowledged back to the real base station 212. Additionally, the real base station never acquires synchronisation with the emulated user terminals 202, 204. The real base station 212 may then report a failure in connection with the emulated user terminals to the RNC 214. In such case, the RNC 214 may be configured to detect that the connection failure report received from the real base station relates to the emulated user terminals 202, 204 and, therefore, the RNC 214 may be further configured not to respond to the connection failure reported by the real base station 212. Accordingly, the real base station 212 receives no instruction to terminate the connection with the emulated user terminals 202, 204 and the data transmission continues and the load of the cell remains at the desired level even though there is no real communication connection between the emulated user terminals 202, 204 and the real base station 212.

FIG. 4 illustrates a diagram of signalling between an emulated user terminal (EUT), a real base station (BS) of the cellular telecommunication network, an emulated base station (EBS), a radio network controller (RNC), and an emulated core network (ECN). The diagram of FIG. 4 illustrates the actions described above; the terminology related to the elements (whether emulated or real) is equivalent to the description related to FIGS. 2A to 3.

In S1, connection set up signalling is carried out between the radio network controller and the emulated core network. The signalling is carried out when the emulated core network has been connected to the lu interface radio network controller. In S2, the corresponding connection set up signalling is carried out between the radio network controller and the emulated base station once the emulated base station has been connected to the lub interface of the radio network controller. S1 and S2 may also be carried out in a different order.

In S3, connection set up signalling is carried out between the emulated user terminal and emulated base station, radio network controller, and emulated core network. The connection set up signalling may be carried out according to the cellular telecommunication network specifications and the signalling may correspond to the signalling carried out when a real user terminal connects to the cellular telecommunication network. In S3, control signalling between the emulated user terminal and the emulated base station, radio network controller, and emulated core network is started, the control signalling comprising transmission of air interface measurements from the user terminal.

In S4, the emulated user terminal signals indication for handover through the emulated base station to the radio network controller. The indication may comprise signal power measurements related to the pilot signals received from the emulated base station and the real base station. The measurements may be modified such that the signal power measurements related to the real base station are considerably higher indicating a higher quality connection.

In S5, the radio network controller acknowledges the handover of the emulated user terminal from the emulated base station to the real base station, and transmits corresponding handover information to the emulated base station, the real base station, and the emulated user terminal. The data between the emulated user terminal and the cellular telecommunication network is now routed through the real base station.

In S6, downlink data traffic is switched and routed from the emulated core network to the emulated user terminal. The data traffic is transmitted from the emulated core network through the radio network controller to the real base station, which then transmits the data traffic to the air interface in order to transmit the data traffic to the emulated user terminal. This increases the load of the cell served by the real base station.

Since there is no real communication connection between the real base station and the emulated user terminal, the emulated user terminal does not receive the transmitted data traffic and cannot acknowledge reception of the data traffic. Therefore, the real base station signals a notice of a failure in connection with the emulated user terminal to the radio network controller in S7. The radio network controller, however, has knowledge that the failure relates to an emulated user terminal and not to a real user terminal and, thus, does not instruct the base station to terminate the connection with the emulated user terminal. Therefore, the base station continues transmission of data traffic to the emulated user terminal in S8 regardless of the detected failure, since the base station receives no instruction to terminate the connection from the radio network controller. Accordingly, transmission of data traffic to the air interface continues and the load of the cell does not decrease due to this failure in acknowledgment of reception of data traffic from the real base station.

The emulating device 100 may be used in optimising or validating a radio access network of the cellular telecommunication network under high load conditions. The emulating device 100 may also be used to regularly benchmark the quality of service of the cellular telecommunication network in order to test and maintain the quality of service of commercial networks. Thus, the emulating device 100 may be used while the network is in commercial use, i.e. in parallel with real user terminals. The amount of data traffic created by the emulating device 100 may be controlled according to the existing load of the cellular telecommunication network in order to obtain a desired load focusing on the network. In practice, if the load caused by real user terminals of the network is already high, the amount of data traffic created by the emulating device 100 may be substantially low. On the other hand, if there are few user terminals transferring data in a particular area of the network (for instance in a cell) and the network is to be tested under extreme load conditions, the amount of data created by the emulating device may be substantially high.

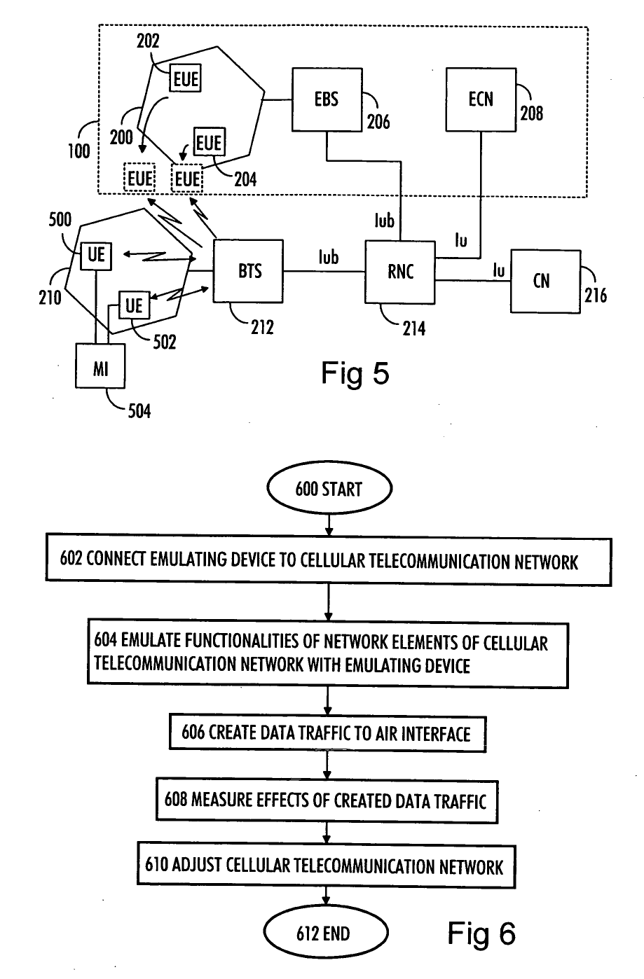

Next, using the emulating device 100 in optimisation of the cellular telecommunication network will be described with reference to FIG. 5. As mentioned above, the emulated user terminals 202, 204 have been handed over to the real base station 212 and the real base station 212 is transmitting data traffic to the air interface of the real cell 210, thereby using the limited capacity of the real base station and causing an increased load in the real cell 210, which may affect the quality of service (QoS) experienced by the real users located in the real cell 210. In order to measure effects of the increased load on the QoS and radio connections between the real user terminals and the real base station 212, one or more test user terminals 500, 502 may be located in the real cell 210. The test user terminals 500, 502 may have an active radio connection with the real base station 212 and may be receiving downlink data traffic from the cellular telecommunication network through the real base station 212 on a regular basis.

The test user terminals 500, 502 may be connected to a measuring instrument 504 which monitors and analyses the performance of the test user terminals 500, 502 and/or the radio links while the test user terminals 500, 502 communicate with the real base station 212. The measuring instrument 504 may monitor, for example, the signal-to-interference ratio, bit error rate, frame error rate, and effective data rate of the received signals in order to detect possible deficiencies in, for example, coverage, capacity, and/or radio resource allocation. Each test user terminal 500, 502 may be connected to a separate measuring instrument 504 or they may be connected to the same measuring instrument as illustrated in FIG. 5. The measuring instrument 504 may also be integrated into the user terminals 500, 502.

Based on the monitoring and analysis carried out by the measuring instrument 504, the cellular telecommunication network is adjusted in order to improve the performance of the network and, consequently, the QoS experienced by the users of the network. The cellular telecommunication network may be adjusted, for example, by increasing the capacity of the network, improving coverage of the network, and/or adjusting radio resource management algorithms of the network.

Although embodiments of the invention described above are related to increasing the load of one real cell 210 of the cellular telecommunication network, the load of a plurality of cells may be increased at the same time in order to measure the effects of the increased load on the plurality of cells. In such case, one or more emulated user terminals may be handed over to each base station which are to be tested under increased load conditions. The handovers may be carried out as described above. Test user terminals and measuring instruments may be located in each cell which is to be tested.

Above, the embodiments of the invention have been described with the emulating device being connected to the radio network controller. In cellular telecommunication systems which do not comprise a radio network controller or an equivalent controller which controls the operation of one or more base stations, the emulating device may be connected between a base station and the core network. In these systems, operations of the radio network controller may be distributed among the base stations and the core network. The embodiments of the invention trigger a soft handover procedure of an emulated user terminal from an emulated cell to a real cell in a cellular telecommunication network. Therefore, it is obvious to one skilled in the art to modify the described embodiments of the invention to connect the emulating device to various cellular telecommunication networks.

Next, a process for optimising a cellular telecommunication network will be described with reference to the flow diagram of FIG. 6. The process starts in block 600.

An emulating device is connected to the cellular telecommunication network in block 602. The emulating device may be connected to a radio network controller of the cellular telecommunication network, for example.

In block 604, functionalities of elements of the cellular telecommunication network are emulated with the emulating device. The emulating device may emulate the functionalities of at least one of the following elements: a base station, a core network, a user terminal.

In block 606, data traffic is created to an air interface of the cellular telecommunication network. The data traffic is created in the emulating device and it may be routed through the cellular telecommunication network to be transmitted to the air interface. The data traffic routing may be preceded by a handover of the one or more emulated user terminals to a base station of the cellular telecommunication network. Accordingly, the data traffic is routed to the one or more emulated user terminals through the base station which was the target base station for handover.

Increased data traffic in the cellular telecommunication network may affect the performance of the network due to the increased load of the cellular telecommunication network. The effects of the increased data traffic are measured in block 608. The measuring may be carried out by using a measuring instrument connected to one or more test user terminals served by the base station which was the target base station for handover.

Based on the measurements, the cellular telecommunication network is adjusted in block 610 in order to improve the performance of the cellular telecommunication network and, consequently, the quality of service experienced by the users of the cellular telecommunication network.

The process ends in block 612.

The embodiments of the invention may be implemented in an emulating device comprising a communication interface and a processing unit operationally connected to the to the communication interface. The processing unit may be configured to perform at least some of the steps described in connection with the flow chart of FIG. 6 and in connection with FIGS. 2A to 5. The embodiments may be implemented as a computer program comprising instructions for executing a computer process for cellular telecommunication network optimisation.

The computer program may be stored on a computer program distribution medium readable by a computer or a processor. The computer program medium may be, for example but not limited to, an electric, magnetic, optical, infrared or semiconductor system, device or transmission medium. The medium may be a computer readable medium, a program storage medium, a record medium, a computer readable memory, a random access memory, an erasable programmable read-only memory, a computer readable software distribution package, a computer readable signal, a computer readable telecommunications signal, and a computer readable compressed software package.

Even though the invention has been described above with reference to an example according to the accompanying drawings, it is clear that the invention is not restricted thereto but it can be modified in several ways within the scope of the appended claims.

1. A cellular telecommunication network optimization method, the method comprising:
connecting an emulating device to the cellular telecommunication network, including creating a signalling link between the emulating device and the cellular telecommunication network;
emulating, with the emulating device, functionalities of elements of the cellular telecommunication network;
creating, with the emulating device, created data traffic to an air interface of the cellular telecommunication network;
measuring effects of the created data traffic on the cellular telecommunication network; and
adjusting the cellular telecommunication network based on the measurements.

2. The method of claim 1, further comprising connecting the emulating device between a base station and a core network of the cellular telecommunication network.

3. The method of claim 1, further comprising connecting the emulating device to a radio network controller of the cellular telecommunication network.

4. The method of claim 1, further comprising emulating functionalities of the following elements of the cellular telecommunication network: a core network, a base station, and a user terminal.

5. The method of claim 4, further comprising creating, by emulating functionalities of the base station, an emulated cell in which the emulated base station provides communication services, the emulated base station having a signalling link with the cellular telecommunication network and functionalities similar to those of a non-emulated base station of the cellular telecommunication network.

6. The method of claim 5, further comprising creating, by emulating functionalities of the user terminal, one or more emulated user terminals within the emulated cell, the one or more emulated user terminals having a signalling connection with the cellular telecommunication network and functionalities similar to those of real user terminals.

7. The method of claim 6, further comprising associating the created data traffic with the one or more emulated user terminals, and switching and routing the created data traffic to the one or more emulated user terminals by emulating functionalities of the core network.

8. The method of claim 6, further comprising:
signalling an indication for handover to a real base station of the cellular telecommunication network from the one or more emulated user terminals to the cellular telecommunication network; and
handing the one or more emulated user terminals over to the real base station.

9. The method of claim 8, further comprising signalling indication for handover comprising transmitting handover information from the one or more emulated user terminals through the emulated base station, the handover information comprising indication that the power level of a pilot signal received from the real base station is higher than the power level of a pilot signal received from the emulated base station.

10. The method of claim 8, further comprising:
switching and routing data from the emulated core network to the one or more emulated user terminals that were handed over to the real base station;
transmitting the data to an air interface from the real base station, thereby increasing traffic in the air interface.

11. The method of claim 10, further comprising continuing transmission of data to the one or more emulated user terminals upon detection of a synchronization failure or a data transfer failure between the real base station and the one or more emulated user terminals.

12. The method of claim 1, the measuring further comprising analysing effects of the created data traffic ~on the performance of one or more real test user terminals in communication connection with the cellular telecommunication network.

13. The method of claim 1, further comprising adjusting the cellular telecommunication network comprising at least one of the following actions: increasing capacity of the network, improving coverage of the network, and adjusting radio resource management algorithms of the network.

14. An emulating device comprising:
a communication interface for connecting the emulating device to a network element of a cellular telecommunication network; and
a processing unit configured to emulate functionalities of elements of the cellular telecommunication network, to create created data traffic to be transmitted to an air interface of the cellular telecommunication network, and to control a real base station of the cellular telecommunication network to transmit the created data traffic to the air interface in order to increase load of the cellular telecommunication network.

15. An emulating device of claim 14, wherein the communication interface connects the emulating device between a base station and a core network of the cellular telecommunication network.

16. An emulating device of claim 14, wherein the communication interface connects the emulating device to a radio network controller of the cellular telecommunication network.

17. An emulating device of claim 14, wherein the processing unit is further configured to emulate functionalities of the following elements of the cellular telecommunication network: a core network, a base station, and a user terminal.

18. An emulating device of claim 17, wherein the processing unit is further configured to create, by emulating functionalities of the base station, an emulated cell in which the emulated base station provides communication services, the emulated base station having a signalling link with the cellular telecommunication network and functionalities similar to those of a real base station of the cellular telecommunication network.

19. An emulating device of claim 17, wherein the processing unit is further configured to create, by emulating functionalities of the user terminal, one or more emulated user terminals within the emulated cell, the one or more emulated user terminals having a signalling connection with the cellular telecommunication network and functionalities similar to those of real user terminals.

20. An emulating device of claim 17, wherein the processing unit is further configured to associate the created data traffic with the one or more emulated user terminals, and switch and route the created data traffic to the one or more emulated user terminals, including emulating functionalities of the core network.

21. An emulating device of claim 17, wherein the processing unit is further configured to transmit, through the communication interface to the cellular telecommunication network, an indication for handover of the one or more emulated user terminals to a real base station of the cellular telecommunication network, and receive, through the communication interface, an indication from the cellular telecommunication network that the one or more user terminals have been handed over to the real base station.

22. An emulating device of claim 21, wherein the processing unit is further configured to emulate core network functionalities by switching and routing the created data through the cellular communication network to the one or more emulated user terminals which were handed over to the real base station.

23. An emulating device of claim 14, wherein the emulating device comprises a personal computer configurable with software.

24. An arrangement that comprises:
a cellular telecommunication network comprising one or more base stations and other network elements, an emulating device comprising a communication interface for connecting the emulating device to a network element of a cellular telecommunication network;
a processing unit configured to emulate functionalities of elements of the cellular telecommunication network, to create data traffic to be transmitted to an air interface of the cellular telecommunication network, and to control a real base station of the cellular telecommunication network to transmit data traffic to an air interface in order to increase load of the cellular telecommunication network; and
measuring instruments capable of measuring properties of the cellular telecommunication network.

25. The arrangement of claim 24, further comprising:
one or more test user terminals in communication with the cellular telecommunication network,
wherein the measuring instrument is configured to analyze the performance of the one or more test user terminals.

26. An emulating device comprising:
communication means for connecting the emulating device to a network element of a cellular telecommunication network;
means for emulating functionalities of elements of the cellular telecommunication network;
means for creating data traffic to be transmitted to an air interface of the cellular telecommunication network; and
means for controlling a real base station of the cellular telecommunication network to transmit data traffic to an air interface in order to increase load of the cellular telecommunication network.

27. An arrangement that comprises:
a cellular telecommunication network comprising one or more base stations and other network elements;
an emulating device comprising communication means for connecting the emulating device to a network element of a cellular telecommunication network and means for emulating functionalities of elements of the cellular telecommunication network;
means for creating data traffic to be transmitted to an air interface of the cellular telecommunication network, and means for controlling a real base station of the cellular telecommunication network to transmit data traffic to an air interface in order to increase load of the cellular telecommunication network; and
measuring instruments comprising means for measuring properties of the cellular telecommunication network.

28. A computer program product embodied on a computer readable medium, the computer program product encoding a computer program of instructions for executing a computer process for cellular telecommunication networkoptimization, the process comprising:
emulating functionalities of elements of the cellular telecommunication network;
creating data traffic to be transmitted to an air interface of the cellular telecommunication network; and
controlling a base station of the cellular telecommunication network to transmit the created data traffic to an air interface in order to increase load of the cellular telecommunication network.

29. A computer program distribution medium readable by a computer and encoding a computer program of instructions for executing a computer process for cellular telecommunication networkoptimization, the process comprising:
emulating functionalities of elements of the cellular telecommunication network;
creating data traffic to be transmitted to an air interface of the cellular telecommunication network; and
controlling a base station of the cellular telecommunication network to transmit the created data traffic to an air interface in order to increase load of the cellular telecommunication network.

30. The computer program distribution medium of claim 29, the distribution medium including at least one of the following media: a computer readable medium, a program storage medium, a record medium, a computer readable memory, a computer readable software distribution package, a computer readable signal, a computer readable telecommunications signal, and a computer readable compressed software package.
